(19) United States
(12) Patent Application Publication
(10) Pub. No.: US 2006/0238908 A1
(43) Pub. Date: Oct. 26, 2006

(54) Timing control circuit for an optical recording apparatus

(76) Inventors: Marinus Adrianus Henricus Looijkens, Eindhoven (NL); James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,405

(22) PCT Filed: Feb. 12, 2004
(86) PCT No.: PCT/IB04/50104

§ 371 Date: Aug. 18, 2005

(30) Foreign Application Priority Data
Feb. 24, 2003 (EP) 03100439.3

(51) Int. Cl. G02B 5/22

(52) U.S. Cl. 359/885

(57) ABSTRACT

An optical recording apparatus (1) is described, for writing information into an optical storage medium such as for instance an optical storage disc, the apparatus comprising a laser diode (30) and a laser diode driver circuit (20), which laser diode driver circuit (20) comprises a flipflop device (25), a write strategy generator and a laser current driver (26), and a timing control circuit (50). The flipflop receives a digital data signal and a digital clock signal. The timing control circuit (50) either delays the digital data signal or the digital clock signal, such as to substantially align data signal edges with passive clock signal edges.

### FIELD OF THE INVENTION

The present invention relates in general to an optical recording apparatus for writing information into an optical storage medium, more particularly but not necessarily exclusively an optical storage disc. Specifically, the present invention relates to a timing control circuit for an optical recording apparatus. Hereinafter, the present invention will be explained for the case of an optical storage disc, and the apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. For writing information in the storage space of a writable optical storage disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, and the way in which information can be stored in an optical disc, is commonly known, it is not necessary here to describe this technology in great detail. For understanding the present invention, it is sufficient to mention that the laser beam is modulated such as to cause a pattern of locations where properties of the disc material have changed, such pattern corresponding to coded information.

More particularly, the laser drive signal is a digital signal which can assume one of two values, indicated as HIGH and LOW or “1” and “0”, respectively. If the laser driver signal is LOW, the laser output power is such that it gives rise to a so-called “land” on the disc material. If the laser driver signal is HIGH, the laser output power is such that it gives rise to a so-called “pit”. The translation of the encoder signal to a laser beam control signal is generally termed a write-strategy and is generally performed by a Write Strategy Generator (WSG).

Said optical scanning means comprise an optical pickup unit, which comprises a laser diode and a laser diode driver. The laser diode driver comprises a flipflop device, as well as a Write Strategy Generator and a laser current driver determining the laser diode driving signal. As will be explained in more detail, the flipflop device has two inputs for receiving a data signal and a clock signal, respectively. Briefly stated, the clock signal is a digital signal determining the timing of changes in the flipflop output signal, whereas the data signal determines the value which the flipflop output signal takes at the moments determined by the clock signal.

For reliably setting a flipflop device to a desired state (i.e. HIGH/LOW), such flipflop device requires that the input signals are stable during a certain time window around the active clock signal edge (setup and hold requirements). If these requirements are not met, data errors may occur.

In this respect, some individual flipflop devices may have more strict setup and hold requirements than others. In fact, these requirements may differ from batch to batch and even from device to device. On the other hand, the clock signal and the data signal are provided by an encoder device, and a phase relationship between the clock signal and the data signal may be different for different encoder devices and may even vary with time for one encoder device, caused for instance by variations in temperature or power supply. The problems mentioned above have increasing severity with increasing writing speed (data rate).

Therefore, it is an important objective of the present invention to reduce the chances on data errors by increasing the stability of the clock signal and the data signal during said flipflop-determined time window.

### SUMMARY OF THE INVENTION

According to an important aspect of the present invention, this objective is attained by providing an automatic alignment between edges of the clock signal and edges of the data signal. This will eliminate or at least reduce phase variations such as for instance caused by process spread, temperature variations, and power supply variations.

It is noted that U.S. Pat. No. 5,475,664 describes a method for reading information from a disc, wherein a read signal is processed to regenerate a data signal and a clock signal by means of a PLL circuit, and wherein the beam focus is adapted to reduce a time difference between an edge of the PLL clock signal and a transition point of the data signal. In contrast, the present invention relates to the write channel, where the timing and frequency of the data signal and the clock signal, respectively, are fixed by the encoder device.

### BRIEF DESCRIPTION OF THE DRAWINGS

These and other aspects, features and advantages of the present invention will be further explained by the following description of the present invention with reference to the drawings, in which same reference numerals indicate same or similar parts, and in which:

FIG. 1 schematically shows a block diagram of an optical writing system;

FIG. 2 is a graph illustrating an aligned timing relationship between a data signal, a clock signal and a retimed data signal;

FIGS. 3A-B are graphs, similar to FIG. 2, illustrating possible misalignment;

FIG. 4 is a schematical block diagram illustrating a timing control circuit according to the present invention.

### DESCRIPTION OF THE INVENTION

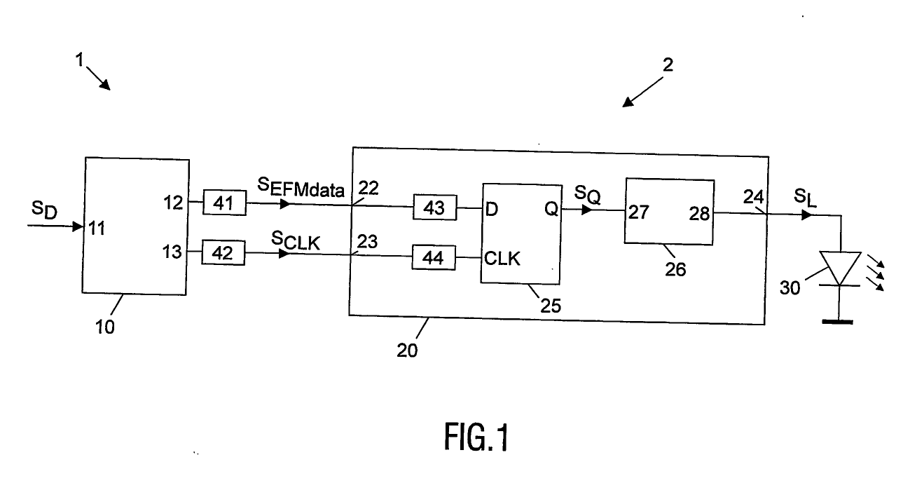

FIG. 1 schematically shows an optical writing system 2 of an optical disc writing apparatus 1. The optical writing system 2 comprises an encoder device 10 having an input 11 for receiving a data signal S_{D} from a data source not shown for sake of simplicity. The encoder 10 performs a coding operation, typically the well-known eight-to-fourteen modulation coding (EFM), and provides an EFM data signal S_{EFMdata} at a data output 12 and an EFM clock signal S_{CLK} at a clock output 13. Since eight-to-fourteen modulation coding is known per se, it is not necessary here to explain this coding scheme in detail.

The optical writing system 2 further comprises a laser diode 30 and a driver circuit 20 for driving the laser diode 30. The driver circuit 20 has a data input 22 coupled to the data output 12 of the encoder 10 for receiving the data signal S_{EFMdata}, and has a clock input 23 coupled to the clock output 13 of the encoder 10 for receiving the clock signal S_{CLK}. The driver circuit 20 further has a drive output 24 coupled to the laser diode 30, providing a laser diode drive signal S_{L}.

As shown in FIG. 1, the driver circuit 20 comprises a laser current driver unit 26, which has an input 27 and an output 28 connected to the drive output 24 of the driver circuit 20. The laser current driver unit 26 in this example comprises a write strategy generator, which is not shown individually.

As shown in FIG. 1, the driver circuit 20 further comprises a D-type flipflop drive device 25, having a data input D coupled to data input 22 of the driver circuit 20, having a clock input CLK coupled to clock input 23 of the driver circuit 20, and having an output Q coupled to the input 27 of the laser current driver unit 26.

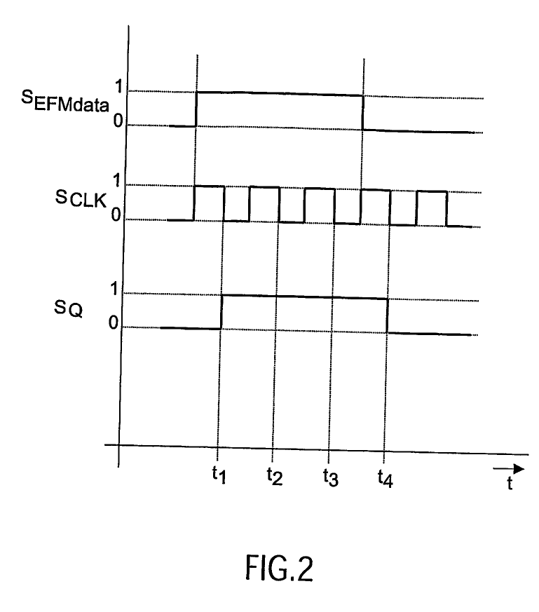

FIG. 2 schematically illustrates the operation of the driver circuit 20. The coded data signal S_{EFMdata} is a digital signal which can take two values, indicated as HIGH and LOW or as “1” and “0”, respectively; transitions between these two values are indicated as signal edges. Likewise, the clock signal S_{CLK} is a digital signal which can take two values, indicated as HIGH and LOW or as “1” and “0”, respectively; transitions between these two values are likewise indicated as signal edges. In both cases, a transition from “0” to “1” will be indicated as a rising edge, while a transition from “1” to “0” will be indicated as a falling edge.

Each time a falling edge of the clock signal S_{CLK} is received at its clock input CLK, the D-type flipflop device 25 makes the value of its output signal at its output Q equal to the instantaneous value of the data signal S_{EFMdata} at its data input D, and this output signal is maintained until the next arrival of a falling edge of the clock signal S_{CLK}. Thus, at time t1 in FIG. 2, flipflop output signal S_{Q} becomes high. At times t2 and t3, flipflop output signal S_{Q} remains high because the data signal S_{EFMdata} at flipflop data input D is still high, but at time t4 flipflop output signal S_{Q} becomes low because now the data signal S_{EFMdata} at flipflop data input D is low. Flipflop output signal S_{Q} can be considered to establish a data signal similar to the data signal S_{EFMdata} but with a different timing, for which reason flipflop output signal S_{Q} is also indicated as retimed data signal.

In the situation shown in FIG. 2, since the flipflop device 25 is responsive to falling edges of the clock signal, the falling edges of the clock signal are indicated as active edges whereas the rising edges of the clock signal are indicated as passive edges.

In the situation shown in FIG. 2, edges of the data signal S_{EFMdata} are aligned with the passive edges of the clock signal S_{CLK.} A timing parameter τ_{DC} between the data signal S_{EFMdat} and the clock signal S_{CLK} will be defined as the time difference between edges of the data signal S_{EFMdat} and the passive edges of the clock signal S_{CLK}. This timing parameter τ_{DC} is equal to zero in the situation shown in FIG. 2.

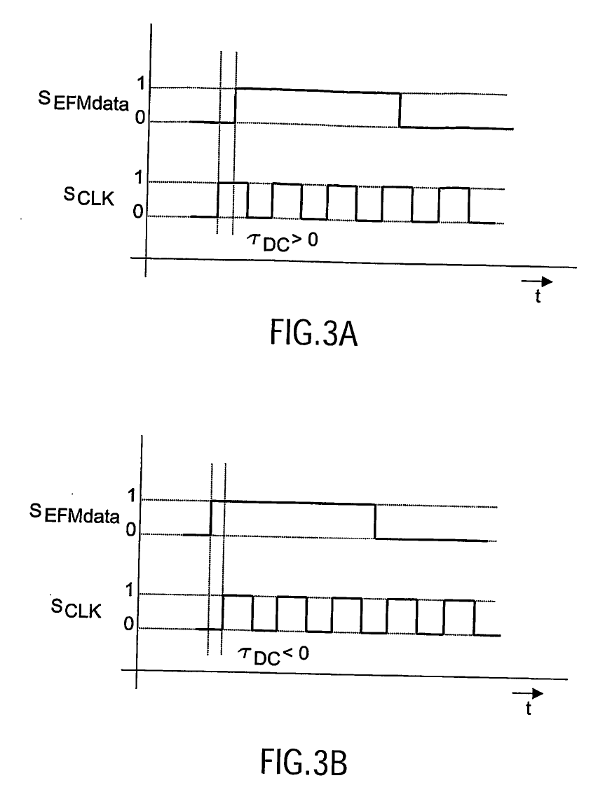

FIG. 3A illustrates a situation where the edges of the data signal S_{EFMdat} arrive somewhat later than the passive edges of the clock signal S_{CLK}; in this case, the timing parameter τ_{DC} will be defined as being positive.

FIG. 3B illustrates a situation where the edges of the data signal S_{EFMdat} arrive somewhat earlier than the passive edges of the clock signal S_{CLK}; in this case, the timing parameter τ_{DC} will be defined as being negative.

It should be clear that the absolute value of the timing parameter τ_{DC} is always smaller than half the period of the clock signal.

With respect to setup and hold time requirements of the flipflop 25, the situation of FIG. 2 (timing parameter τ_{DC}=0) is ideal, because then the time interval between the occurrence of a data signal edge and the closest active clock signal edge is maximal.

The timing parameter τ_{DC} may vary from device to device, while for one device the timing parameter τ_{DC} may vary with time. This is represented by internal delays 41 and 42 at the outputs 12 and 13 of the encoder 10, and by internal delays 43 and 44 at the inputs 22 and 23 of the driver 20. Internal delays 41 and 42 represent timing differences as occurring inside the encoder 10, whereas internal delays 43 and 44 represent timing differences as caused by the signal transfer between encoder 10 and flipflop 25.

It is desirable to have the timing parameter τ_{DC} as measured at the D and CLK inputs of flipflop 25 to be as small as possible, preferably equal to zero.

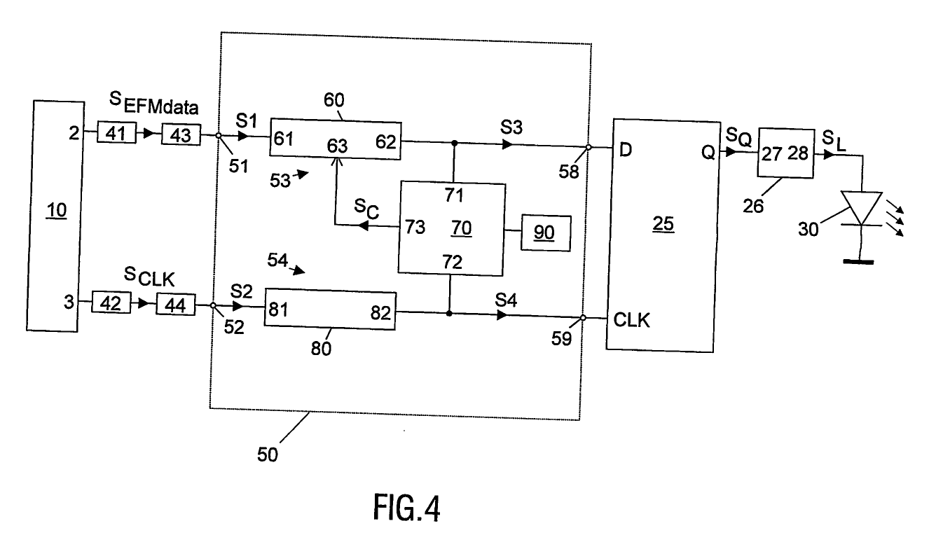

To this end, the present invention provides a timing control circuit 50, which can be implemented as a unit to be connected between encoder 10 and driver 20, but which preferably, as illustrated in FIG. 4, is arranged directly before the D and CLK inputs of flipflop 25.

It is noted that the timing control circuit 50 is an embodiment of the present invention which may be usable for other applications.

The timing control circuit 50 has two inputs 51 and 52 for receiving two signals S1 and S2, and two outputs 58 and 59 for outputting two signals S3 and S4. In the practical application illustrated in FIG. 4, first input 51 receives the data signal S_{EFMdat} as first input signal S1, and second input 52 receives the clock signal S_{CLK} as second input signal S2, while first output 58 and second output 59 are connected to the data input D and the clock input CLK of flipflop 25, respectively.

A first signal path from first input 51 to first output 58 is indicated at 53; a second signal path from second input 52 to second output 59 is indicated at 54. In at least one of said signal paths 53, 54, a controllable delay is incorporated. In the embodiment as illustrated, a controllable delay 60 is incorporated in first signal path 53, having a signal input 61 connected to first input 51, having a delayed signal output 62 connected to first output 58, and having a control input 63.

The controllable delay device 60 is designed to provide at its delayed signal output 62 a first delayed signal S3 which is equal to the first input signal S1 received at its signal input 61 but delayed over a first predetermined delay time τ1, the duration of which is determined by a control signal received at control input 63. Since controllable delay devices are known per se, whereas the present invention does not relate to controllable delay devices as such, while a known per se controllable delay device can be used when implementing the present invention, it is not necessary here to discuss the design and operation of the controllable delay device in more detail.

The timing control circuit 50 further comprises a phase comparator 70, having a first input 71 connected to first output 58, having a second input 72 connected to second output 59, and having a control output 73 connected to control input 63 of the controllable delay device 60.

The phase comparator 70 is designed to compare the phases of two signals received at its two inputs 71, 72, and to generate a control signal S_{C} for the controllable delay device 60, such that the time difference between edges of both input signals is reduced, preferably zero.

Since phase comparators are known per se, whereas the present invention does not relate to phase comparators as such, while a known per se phase comparator can be used when implementing the present invention, it is not necessary here to discuss the design and operation of the phase comparator in more detail.

Preferably, the phase comparator 70 comprises a low-pass filter function for filtering the input signals received at its two inputs 71, 72.

In case the first signal S1, i.e. data signal S_{EFMdat}, is somewhat ahead of the second signal S2, i.e. clock signal S_{CLK}, aligning the two signals can be easily achieved by the timing control circuit 50 because the phase comparator 70 generates its control signal S_{C} for applying a relatively small delay to the first signal S1. In case, however, the first signal S1 is somewhat behind the second signal S2, applying a small delay to the first signal S1 will only increase the time difference between edges of both input signals, and a large delay is necessary, in the order of the clock period minus the original timing difference. Therefore, in a preferred embodiment, as illustrated also in FIG. 4, the timing control circuit 50 further comprises a second delay device in the other of the two transfer paths, namely a second delay device 80 in second signal transfer path 54. The second delay device 80 has a signal input 81 connected to second input 52 and has a delayed signal output 82 connected to second output 59.

Then, it is effectively possible to delay the clock signal with respect to the data signal.

The second delay device 80 may be a controllable delay device, like the first delay device 60, but this is not necessary. It is sufficient if the second delay device 80 is a fixed delay device 80 designed to provide at its delayed signal output 82 a second delayed signal S4 which is equal to the second input signal S2 received at its signal input 81 but delayed over a second predetermined delay time τ2, the duration of which being fixed.

In case the first signal S1 is already aligned with the second signal S2, the phase comparator 70 generates its control signal S_{C} such that the first delay time τ1 is equal to the second delay time τ2, so that the output signals S3 and S4 are also aligned. In case the first signal S1 is somewhat ahead of the second signal S2, the phase comparator 70 generates its control signal S_{C} such that the first delay time τ1 is larger than the second delay time τ2 (more particularly: τ1=τ2+τ).

In case the first signal S1 is somewhat behind the second signal S2, the phase comparator 70 generates its control signal S_{C} such that the first delay time τ1 is smaller than the second delay time τ2 (more particularly: τ1=τ2−τ).

Preferably, the phase comparator 70 is associated with a non-volatile memory 90. Into this memory 90, the timing control circuit 50 stores a value representing the magnitude (voltage) of the control signal S_{C}. The timing control circuit 50 may be designed to regularly store the magnitude of the current control signal, or to store this magnitude just before power off. In any case, the timing control circuit 50 is designed to read the memory 90 on power up and to use the stored value for determining (an initial value of) the control signal S_{C}.

In a possible embodiment, a digital value representing the magnitude of the current control signal may be stored into the memory 90 using an Analog-to-Digital Converter (ADC), not shown for sake of simplicity, while the control signal may be restored using a Digital-to-Analog Converter (DAC), not shown for sake of simplicity, for reading the memory 90.

Thus, the present invention succeeds in providing an optical recording apparatus for writing information into an optical storage medium such as for instance an optical storage disc, which apparatus comprises a laser diode 30, a laser driver circuit 20 comprising a flipflop device 25, and a timing control circuit 50. The flipflop receives a digital data signal and a digital clock signal.

The timing control circuit 50 either delays the digital data signal or the digital clock signal, such as to substantially align data signal edges with passive clock signal edges.

It should be clear to a person skilled in the art that the present invention is not limited to the exemplary embodiments discussed above, but that various variations and modifications are possible within the protective scope of the invention as defined in the appending claims.

For instance, the output signal of driver circuit 20 may be inverted with respect to the EFM data signal.

Also, the flipflop device 25 may respond to rising edges of the clock signal, in which case phase difference zero corresponds to alignment of data signal edges with falling clock signal edges.

Further, the controllable delay device may be incorporated in the clock signal transfer line 54 while the data signal transfer line 53 may contain a fixed delay device or may contain no delay device.

Further, it is possible that the optical writing system 2 comprises an inverter arranged between clock signal output 13 of the encoder 10 and second input 52 of the timing control circuit 50, in order to effect that rising edges in the clock signal S_{CLK} become falling edges in the clock signal S4 as appearing at the clock signal input CLK of the flipflop 25, and vice versa. Such inverter is preferably a controllable inverter, for instance implemented as an EXOR gate, receiving the clock signal S_{CLK} at one input terminal and receiving a selection signal at a second input terminal, as will be clear to a person skilled in the art. With such controllable inverter, it is possible to select either the falling edges or the rising edges of the encoder output clock signal S_{CLK} as active edge, depending on whether the data signal edges are closer to the falling edges or the rising edges of the encoder output clock signal S_{CLK}. In that case, a suitable value for the fixed delay τ2 of the second delay device 80 is one quarter of the clock period, and the required delay time τ1 of the controllable delay device 60 may be selected in the range from zero to one half of the clock period.

Further, it is noted that the invention is applicable in optical recording apparatus for write-once recording material as well as for rewritable recording material. Further, it is noted that the invention is not limited to recording material in the shape of rotating discs.

1. Timing control circuit (50) for an optical recording apparatus, comprising:
a first circuit input (51), a first circuit output (58), and a first signal transfer path (53) between first circuit input and first circuit output;
a second circuit input (52), a second circuit output (59), and a second signal transfer path (54) between second circuit input and second circuit output;
controllable delay means (60) incorporated in at least one (53) of said signal transfer paths (53, 54), designed for delaying a signal (S1) transferred along said path (53) by a certain delay time (τ1);
a phase comparator (70) having a first input (71) coupled to said first circuit output (58), having a second input (72) coupled to said second circuit output (59), and having a control output (73) for providing a control signal (S_{C}) for said controllable delay means (60);
wherein the phase comparator (70) is designed to generate its control signal (S_{C}) such that signals (S3, S4) as appearing at its inputs (71, 72) are substantially aligned.

2. Timing control circuit according to claim 1, wherein the phase comparator (70) comprises a low-pass filter function for filtering the input signals received at its two inputs (71, 72).

3. Timing control circuit according to claim 1, wherein said controllable delay means (60) has an input (61) coupled to a circuit input (51), an output (62) coupled to a corresponding circuit output (58), and a control input (63) coupled to said control output (73) of said phase comparator (70).

4. Timing control circuit according to claim 1, wherein said timing control circuit further comprises a second delay device (80) in the other (54) of the two transfer paths (53, 54).

5. Timing control circuit according to claim 4, wherein said second delay device (80) is a fixed delay device causing a fixed delay time (τ2).

6. Timing control circuit according to claim 1, wherein said timing control circuit further comprises a non-volatile memory (90) associated with said phase comparator (70); wherein the timing control circuit is designed to store into said memory (90) a value representing the magnitude of the control signal (S_{C}).

7. Timing control circuit according to claim 6, wherein the timing control circuit is designed to regularly store the magnitude of the current control signal (S_{C}).

8. Timing control circuit according to claim 6, wherein the timing control circuit is designed to store the magnitude of the current control signal (S_{C}) just before power off.

9. Timing control circuit according to claim 6, wherein the timing control circuit is designed to read the memory (90) on power up and to use the stored value for determining a setting of the control signal (S_{C}).

10. Timing control circuit according to claim 1, wherein said controllable delay means (60) has an input (61) coupled to a first circuit input (51), an output (62) coupled to a first circuit output (58), and a control input (63) coupled to said control output (73) of said phase comparator (70), the controllable delay means (60) being designed to receive a first input signal (S1) and to provide a first delayed digital output signal (S3) which is delayed by a first delay time (τ1) with respect to the input signal (S1);
the circuit further comprising a second delay device (80) having an input (81) coupled to a second circuit input (52), an output (82) coupled to a second circuit output (59), the second delay means (80) being designed to receive a second input signal (S2) and to provide a second delayed digital output signal (S4) which is delayed by a second delay time (τ2) with respect to the input signal (S1);
wherein the phase comparator (70) is designed to generate its control signal (S_{C}) such that the first delay time (τ1) is set such that timing of edges of the first delayed digital output signal (S3) substantially correspond to timing of edges of the second delayed digital output signal (S4).

11. Method for generating a retimed data signal (S_{Q}) for a laser current driver (26) in an optical recording apparatus (1), the method comprising the steps of:
providing a flipflop (25) having a data signal input (D), a clock signal input (CLK), and a drive output (Q) for outputting said retimed data signal (S_{Q});
providing a digital data signal (S_{EFMdata}; S3) having data signal edges;
applying the digital data signal (S_{EFMdata}; S3) to the data signal input (D) of the flipflop (25);
providing a digital clock signal (S_{CLK}; S4) having active clock signal edges and passive clock signal edges;
applying the digital clock signal (S_{CLK}; S4) to the clock signal input (CLK) of the flipflop (25);
the method further comprising the step of substantially aligning data signal edges with passive clock signal edges.

12. Method according to claim 11, further comprising the step of comparing the timing of data signal edges and the timing of passive clock signal edges, and the step of delaying at least one of said signals such as to reduce any time difference (τ) between data signal edges and passive clock signal edges.

13. Optical writing system (2) for an optical disc writing apparatus (1), comprising:
a laser diode (30);
a laser driver circuit (20) comprising a flipflop device (25) which receives a digital data
signal (S_{EMFdata}; S3) and a digital clock signal (S_{CLK}; S4);
and a timing control circuit (50) adapted for delaying either the digital data signal or the digital clock signal, such as to substantially align data signal edges with passive clock signal edges.

14. Optical writing system according to claim 13, wherein the timing control circuit (50) is designed in accordance with any of claims 1-10.

15. Optical writing system (2) for an optical disc writing apparatus (1), comprising:
an encoder device (10) having an input (11) for receiving a data signal (S_{D}), a data output (12) for providing a coded data signal (S_{EFMdata}), and a clock output (13) for providing a clock signal (S_{CLK});
a laser driver circuit (20) having a data input (22) coupled to the data output (12) of the encoder (10), having a clock input (23) coupled to the clock output (13) of the encoder (10), and having a drive output (24) coupled to the laser diode (30); the laser driver circuit (20) comprising:
a flipflop device (25), having a data input (D) coupled to the data input (22) of the laser driver circuit (20), having a clock input (CLK) coupled to the clock input (23) of the laser driver circuit (20), and having an output (Q) for outputting a retimed data signal (S_{Q});
a laser driver circuit (26), having an input (27) coupled to the flipflop output (Q), and having an output (28) coupled to the drive output (24) of the laser driver circuit (20); the optical writing system (2) being designed to perform the method according to any of claims 11-12.

16. Optical writing system according to claim 15, wherein the optical writing system (2) comprises a timing control circuit (50) according to any of claims 1-10, arranged between encoder device (10) and driver circuit (20).

17. Optical writing system according to claim 16, wherein the timing control circuit (50) is arranged immediately before the flipflop drive device (25).

18. Optical writing system according to claim 15, further comprising a write strategy generator arranged between the flipflop output (Q) and the input (27) of the laser driver circuit (26).

19. Optical recording apparatus (1) for writing information into an optical storage medium, comprising an optical writing system (2) according to any of claims 13-18.
